(19) United States
(12) Patent Application Publication
(10) Pub. No.: US 2008/0088928 A1
(43) Pub. Date: Apr. 17, 2008

(54) OPTICAL CONFIGURATIONS FOR ACHIEVING UNIFORM CHANNEL SPACING IN WDM TELECOMMUNICATIONS APPLICATIONS

(75) Inventor: James M. Tedesco, Livonia, MI (US)

Correspondence Address: GIFFORD, KRASS, SPRINKLE,ANDERSON & CITKOWSKI, P.C, PO BOX 7021, TROY, MI, 48007-7021, US

(73) Assignee: Kaiser Optical Systems, Ann Arbor, MI (US)

(21) Appl. No.: 11/744,923

(22) Filed: May 7, 2007

Related U.S. Application Data
(60) Provisional application No. 60/829,341, filed on Oct. 13, 2006.

(51) Int. Cl. G02B 27/44

(52) U.S. Cl. 359/566

(57) ABSTRACT

Optical diffraction configurations provide uniform physical channel spacing in dense wavelength division multiplexing (DWDM) applications. A grating has a dispersed side outputting (or receiving) or a plurality of spaced-apart optical frequencies or wavelengths to (or from) an image plane, and a prism is supported between the dispersed side of the grating and image plane improve the uniformity of the spacing between optical frequencies or wavelengths at the image plane. The diffraction grating may be a transmission or reflection grating. The diffraction grating is preferably a volume-phase holographic (VPH) grating. A second prism may be used such that the input and output beams have a substantially identical aperture.

### REFERENCE TO RELATED APPLICATION

This application claims priority from U.S. Provisional Patent Application Ser. No. 60/829,341, filed Oct. 13, 2006, the entire content of which is incorporated herein by reference.

### FIELD OF THE INVENTION

This invention relates generally to optical telecommunications and, in particular, to optical diffraction grating and prism configurations for uniform physical channel spacing in dense wavelength division multiplexing (DWDM) applications.

### BACKGROUND OF THE INVENTION

Diffraction gratings are commonly used in optical telecommunications to separate or combine optical data channels being carried on different laser wavelengths. The technology is well known in the industry as Dense Wavelength Division Multiplexing (DWDM, or just WDM). The light beams carrying different channels are conducted to and from the multiplexing device using fiber optics. A diffraction grating, combined with imaging lenses, can separate several different wavelengths of light carried on a common input fiber into several different output fibers, as shown in FIG. 1. These fibers can then route the corresponding data channels to different locations in a communications network. This device would be called a demultiplexer. The same device in reverse would constitute a multiplexer. Variations of this device can be incorporated into add/drop multiplexers, tunable optical filters, optical channel monitors, etc., as is well known.

Optical data channels are standardized by the International Telecommunications Union (ITU) to a grid separated uniformly in optical frequency. The C-band, for example, ranges in frequency from approximately 191 to 197 THz, corresponding to optical wavelengths of approximately 1520 to 1570 nm. DWDM channels within the C-band are separated in uniform increments of 50 or 100 GHz (0.05 or 0.1 THz).

FIG. 1 shows a well-known multiplexer/demultiplexer geometry that provides very high, polarization-independent efficiency in a volume-phase holographic (VPH) transmission grating. The geometry shown uses a grating frequency of approximately 940 lines/mm for C-band applications and assumes ideal 100 mm focal length, distortion-free lenses. The grating/lens configuration of FIG. 1 does not produce a uniform spatial separation of the ITU channels that are uniformly spaced in frequency (nor would it uniformly separate uniformly spaced wavelengths, for that matter).

FIG. 2 shows the physical separation of 100 GHz channels across the C-band. 100 GHz channel separation produced by this configuration ranges from 103 microns at the low end of C-band, to 115 microns at the high end of C-band. This range can be scaled up or down with the focal length of the lens. The non-uniformity of the channel spacing precludes the use of inexpensive, mass-produced fiber spacing devices designed to hold arrays of fibers at uniform spatial separation. It also precludes the use of uniformly spaced detector arrays for building channel monitors with a single detector per channel. This presents obvious cost, complexity, or performance issues when constructing such devices.

This non-uniformity is a result of the nonlinear relationship between the output frequency or wavelength, and the output angle from the grating, as governed by the laws of physics and represented by the well-known grating equation:

Sin(θ1)+Sin(θ2)=Nλ/D,

where θ1 and θ2 are the input and output angles, N is the refractive index of the medium, and is the wavelength of light being diffracted, and D is the grating period.

### SUMMARY OF THE INVENTION

This invention resides in optical diffraction grating and prism configurations providing uniform physical channel spacing in dense wavelength division multiplexing (DWDM) applications.

The apparatus broadly includes a diffraction grating having a dispersed side outputting (or receiving) or a plurality of spaced-apart optical frequencies or wavelengths to (or from) an image plane, and a prism supported between the dispersed side of the grating and image plane to improve the uniformity of the spacing between optical frequencies or wavelengths at the image plane. In the preferred embodiment, the prism is supported immediately adjacent to the dispersed side of the grating.

The diffraction grating may be a transmission or reflection grating. The diffraction grating is preferably a volume-phase holographic (VPH) grating. A second prism may be used such that the input and output beams have a substantially identical aperture.

Given this basic configuration, a plurality of spaced-apart optical fibers may be used to deliver (or receive) the spaced-apart optical frequencies or wavelengths to (or from) the grating. The dispersed side of the grating may output a plurality of spaced-apart optical frequencies or wavelengths as part of a wavelength division demultiplexer in an optical telecommunications system. Alternatively, the dispersed side may output a plurality of spaced-apart optical frequencies or wavelengths as part of a channel monitor or spectrograph with uniform detector spacing mapping to uniform channel spacing.

### BRIEF DESCRIPTION OF TIE DRAWINGS

FIG. 1 shows a standard 940 line/mm grating geometry for C-band DWDM;

FIG. 2 shows a 100 GHz Channel Spacing with standard 940 grating and 100 mm EFL lens;

FIG. 3 shows a 940 l/mm grating with compensating 61.5° output prism;

FIG. 4 shows a 100 GHz Channel spacing with compensating 61.5° output prism;

FIG. 5 shows a 940 l/mm grating with input & output prisms; and

FIG. 6 shows a spacing-compensated 940 l/mm reflection grating.

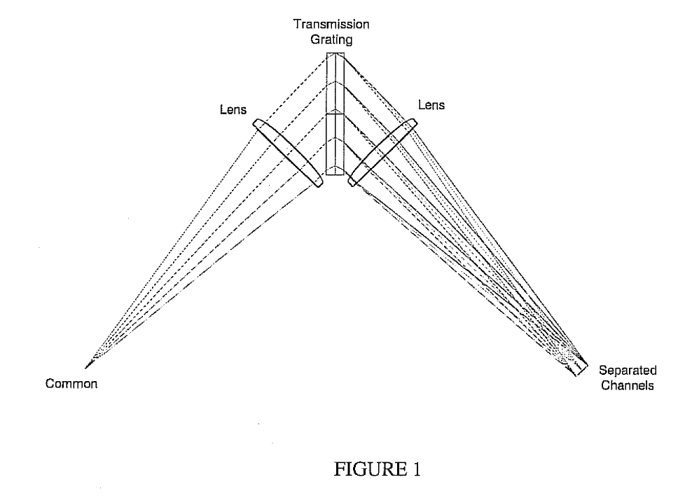

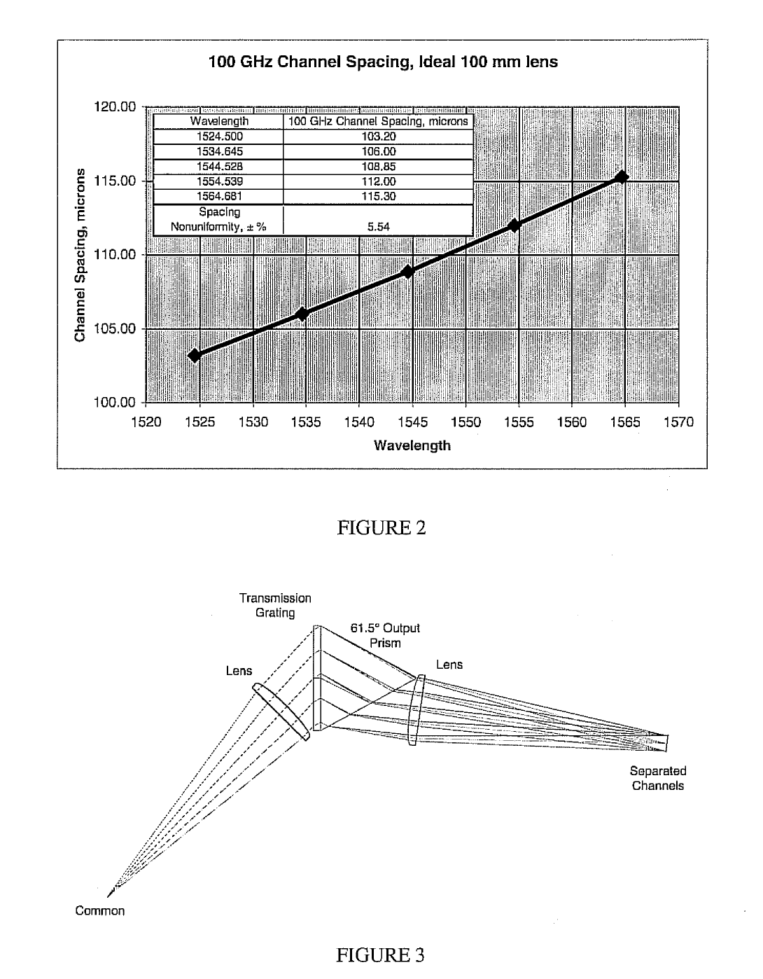

### DETAILED DESCRIPTION OF THE INVENTION

The present invention compensates this non-uniform channel spacing through the novel application of a grating/prism combination. In accordance with the invention, for a given grating geometry, a prism can be designed that balances the nonlinearity of the diffraction grating equation with the nonlinearity of the well-known Snell's law of refraction:

N1*Sin(θ1)=N2*Sin(θ2).

Where θ1 and θ2 are the input and output angles, and N1 and N2 are the refractive indices of the input and output media.

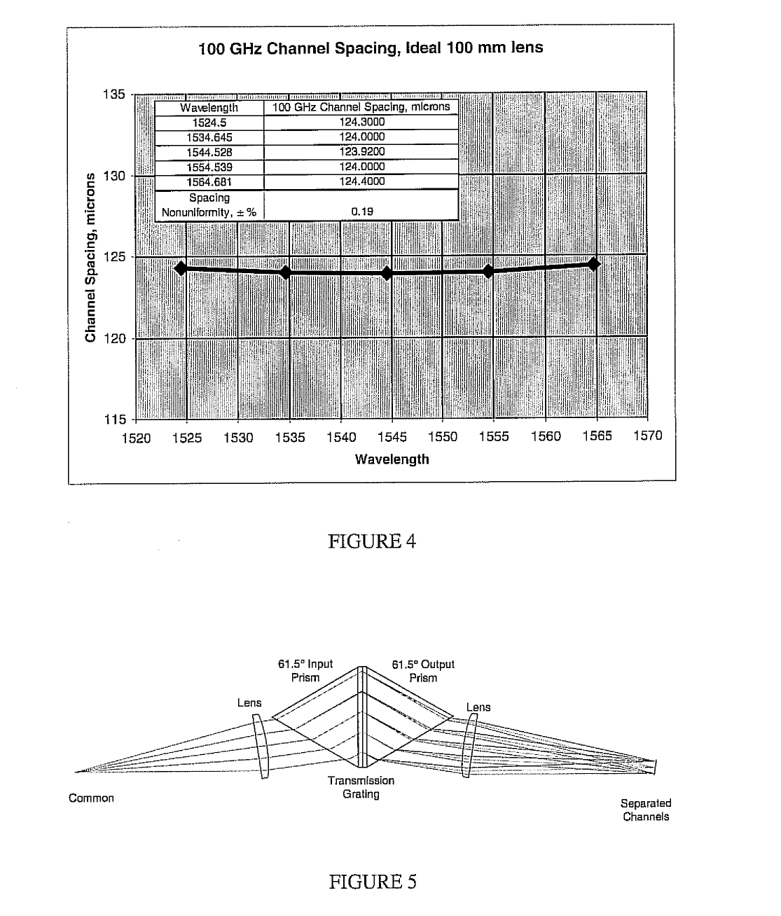

With respect to C-band telecommunications, such compensation is provided using a high-efficiency, substantially polarization-independent grating having approximately 940 lines/mm and a prism constructed of BK7 or similar glass having an input surface parallel to the grating and an output surface tilted at approximately 61.5 degrees with respect to the grating surface. This compensated geometry is shown in FIG. 3. The 100 GHz channel spacing nonuniformity across the C-band, shown in FIG. 4, has been reduced from a problematic 12.1 microns to less than 0.5 microns. Note also that the absolute dispersion has increased from a ˜110 micron average channel spacing, to ˜124 microns. This is generally desirable. Again, spacing of the focused frequencies can be adjusted up or down at will with the focal length of the lens.

The invention may be applied to other grating geometries, which will be similarly compensated at other prism angles. The same concept can also be applied with a similar prism on the input side of the grating, as shown in FIG. 5. This input prism has little impact on channel spacing, but may be desirable for device symmetry and/or to avoid anamorphic aperture stretching between the input and output beams, which may be required for efficient fiber coupling.

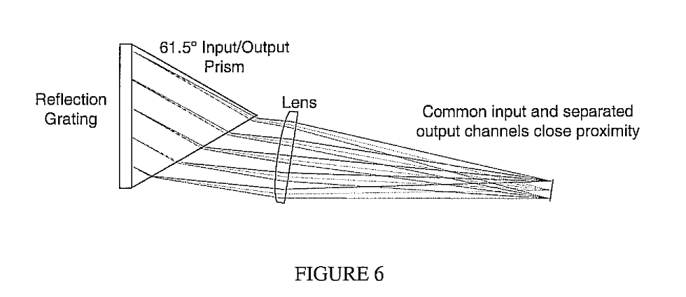

The invention may also be applied to a reflection grating, as shown in FIG. 6, where the output is a mirror image of the equivalent transmission grating geometry for the same grating frequency. The same equations and correcting prism angles apply.

The above describes a design that renders uniform optical channel spacing uniform as measured in optical frequency. Optical frequency, f, and optical wavelength, λ, are related by yet another nonlinear function:

f=c/λ,

where c is the speed of light, a constant. Because of this nonlinear relationship, a different prism angle is required to generate uniform wavelength spacing than would be used to generate uniform frequency spacing. The design concept is otherwise identical.

I claim:

1. Optical apparatus, comprising:
a diffraction grating having a dispersed side outputting (or receiving) a plurality of spaced-apart optical frequencies or wavelengths to (or from) an image plane; and
a prism supported between the dispersed side of the grating and image plane to improve the uniformity of the spacing between optical frequencies or wavelengths at the image plane.

2. The optical apparatus of claim 1, wherein the prism is immediately adjacent to the dispersed side of the grating.

3. The optical apparatus of claim 1, wherein the diffraction grating is a transmission or reflection grating.

4. The optical apparatus of claim 1, wherein the diffraction grating is a holographic grating.

5. The optical apparatus of claim 1, wherein the diffraction grating is volume-phase holographic (VPH) grating.

6. The optical apparatus of claim 1, further including a second prism to render input and output beams having a substantially identical aperture.

7. The optical apparatus of claim 1, further including a plurality of spaced-apart optical fibers to deliver (or receive) the spaced-apart optical frequencies or wavelengths to (or from) the grating.

8. The optical apparatus of claim 1, wherein the dispersed side outputs a plurality of spaced-apart optical frequencies or wavelengths as part of a wavelength division demultiplexer in an optical telecommunications system.

9. The optical apparatus of claim 1, wherein the dispersed side receives a plurality of spaced-apart optical frequencies or wavelengths as part of a wavelength division multiplexer in an optical telecommunications system.

10. The optical apparatus of claim 1, wherein the dispersed side outputs a plurality of spaced-apart optical frequencies or wavelengths as part of a channel monitor or spectrograph with uniform detector spacing mapping to uniform channel spacing.

11. The optical apparatus of claim 1, wherein,
the grating is a high-efficiency, substantially polarization-independent grating having approximately 940 lines/mm configured for use with C-band telecommunications; and
the prism is constructed of BK7 or similar glass having an input surface parallel to the grating and an output surface tilted at approximately 61.5 degrees with respect to the grating surface.

12. Optical apparatus, comprising
a diffraction grating having a dispersed side outputting (or receiving) a plurality of spaced-apart optical frequencies or wavelengths to (or from) an image plane; and
a prism mounted to the dispersed side of the grating at an angle such that the nonlinearity of Snell's law of refraction at the prism interface balances the nonlinearity of the diffraction grating angle versus wavelength or frequency, thereby improving the uniformity of the spacing between optical frequencies or wavelengths at the image plane.

13. The optical apparatus of claim 12, wherein the diffraction grating is a transmission or reflection grating.

14. The optical apparatus of claim 12, wherein the diffraction grating is holographic.

15. The optical apparatus of claim 12, wherein the diffraction grating is volume-phase holographic (VPH) grating.

16. The optical apparatus of claim 12, further including a second prism to render input and output beams having a substantially identical aperture.

17. The optical apparatus of claim 12, further including a plurality of spaced-apart optical fibers to deliver (or receive) the spaced-apart optical frequencies or wavelengths to (or from) the grating.

18. The optical apparatus of claim 12, wherein the dispersed side outputs a plurality of spaced-apart optical frequencies or wavelengths as part of a wavelength division demultiplexer in an optical telecommunications system.

19. The optical apparatus of claim 12, wherein the dispersed side receives a plurality of spaced-apart optical frequencies or wavelengths as part of a wavelength division multiplexer in an optical telecommunications system.

20. The optical apparatus of claim 12, wherein the dispersed side outputs a plurality of spaced-apart optical frequencies or wavelengths as part of a channel monitor or spectrograph with uniform detector spacing mapping to uniform channel spacing.

21. The optical apparatus of claim 12, wherein:
the grating is a high-efficiency, substantially polarization-independent grating having approximately 940 lines/mm configured for use with C-band telecommunications; and
the prism is constructed of B7 or similar glass having an input surface parallel to the grating and an output surface tilted at approximately 61.5 degrees with respect to the grating surface.
